(19) United States
(12) Patent Application Publication
(10) Pub. No.: US 2026/0032561 A1
(43) Pub. Date: Jan. 29, 2026

(54) REGULATING NON-CELLULAR CONNECTIVITY FROM EXTERNAL CELLULAR SUBSCRIBERS

(71) Applicant: Charter Communications Operating, LLC, St. Louis, MO (US)

(72) Inventors: Hany Heikal, Aurora, CO (US); Mohamed Daoud, Aurora, CO (US); Loay O. Kreishan, Aurora, CO (US)

(73) Assignee: Charter Communications Operating, LLC, St. Louis, MO (US)

(21) Appl. No.: 19/350,583

(22) Filed: Oct. 6, 2025

Related U.S. Application Data
(63) Continuation-in-part of application No. 18/671,436, filed on May 22, 2024.

(51) Int. Cl. H04W 48/02; H04W 8/20; H04W 8/22

(52) U.S. Cl. CPC H04W 48/02; H04W 8/20; H04W 8/22

(57) ABSTRACT

A method for selectively providing Internet service to UEs by a company that functions as both a cellular service provider and an Internet service provider (ISP). In some embodiments, a request from a UE is received for Internet access via a non-cellular (e.g., WiFi) network, wherein the request identifies the UE's MAC address. If the UE has a SIM module, then the UE's IMEI/IMSI number is requested, received, and used to determine whether the UE is associated with a cellular service subscriber of the company. If so, then the Internet access via the non-cellular network is permitted; otherwise, the Internet access is denied. In this way, the company's ISP service can be restricted to its cellular service subscribers.

### CROSS-REFERENCE TO RELATED APPLICATIONS

This is a continuation-in-part of co-pending application Ser. No. 18/671,436, filed on May 22, 2024, the teachings of which are incorporated herein by reference in their entirety.

### BACKGROUND

### Field of the Disclosure

The present disclosure relates to wireless communications and, more specifically but not exclusively, to wireless communications over non-cellular networks, such as WiFi networks.

### Description of the Related Art

This section introduces aspects that may help facilitate a better understanding of the disclosure. Accordingly, the statements of this section are to be read in this light and are not to be understood as admissions about what is prior art or what is not prior art.

It is known for a company to be both a cellular service provider, for example, via LTE and 5G networks, and an Internet service provider (ISP), for example, via WiFi networks, where the company's ISP service is available to both subscribers to the company's cellular service and non-subscribers.

### SUMMARY

The present disclosure is related to technology that prevents non-subscribers to a company's cellular service from accessing the company's ISP service.

In at least one embodiment, the present disclosure is a method for selectively providing Internet access to user equipments (UEs) by a company that functions as both a cellular service provider and an Internet service provider. The method comprises receiving a request from a UE for Internet access via a non-cellular network; determining whether the UE is associated with a cellular service subscriber of the company; upon determining that the UE is associated with a cellular service subscriber of the company, permitting the Internet access by the UE via the non-cellular network; and upon determining that the UE (i) has cellular communication capabilities and (ii) is not associated with a cellular service subscriber of the company, denying the Internet access by the UE via the non-cellular network.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a message flow diagram representing a prior-art sequence of messages transmitted between user equipment and the access point of a WiFi network to establish a wireless connection between the UE and the AP to enable the UE to access the Internet via the AP's WiFi network;

FIG. 2 is a simplified block diagram of a situation in which two different users attempt to use their UEs to access a company's ISP service via a WiFi network, where only one of the two users is a subscriber to the company's cellular service;

FIG. 3 is a flow diagram of the processing performed by the AP of FIG. 2 to determine whether or not to allow a UE to access the Internet via the AP's WiFi network;

FIG. 4 is a message flow diagram representing a sequence of messages transmitted between the UE and the AP of FIG. 2 to establish a wireless connection between the UE and the AP to enable the UE to access the Internet via the AP's WiFi network according to an embodiment of the present disclosure; and

FIG. 5 is a simplified hardware block diagram of an example element that can be used to implement any of the elements of FIG. 2.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

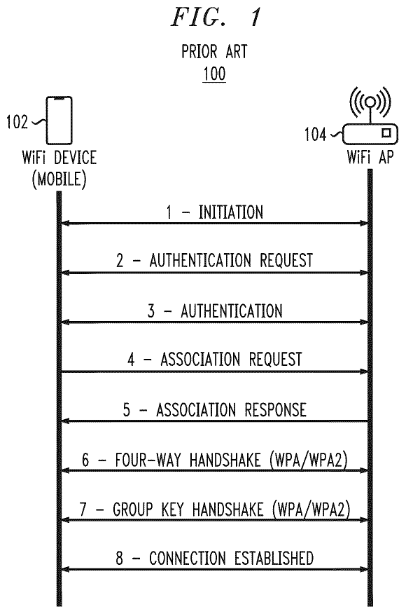

FIG. 1 is a message flow diagram representing a prior-art sequence 100 of messages transmitted between user equipment (UE) 102 (e.g., a cellular phone or other similar wireless device having WiFi capabilities) and the access point (AP) 104 of a WiFi network to establish a wireless connection between the UE 102 and the AP 104 to enable the UE 102 to access the Internet via the AP's WiFi network.

In step 1 (Initiation), the UE 102 sends a probe request frame to discover nearby WiFi networks, and nearby AP 104 responds with probe response frames containing its Service Set Identifier (SSID).

In step 2 (Authentication Request), the UE 102 (or the UE's user) selects the AP's WiFi network and sends, to the AP 104, an authentication request frame containing the UE's Medium Access Control (MAC) address and authentication algorithm support.

In step 3 (Authentication), the AP 104 responds with an authentication frame. There are two types of authentication: Open System Authentication and Shared Key Authentication.

In Open System Authentication, the AP 104 typically accepts any device. In Shared Key Authentication, the AP 104 challenges the device to authenticate by encrypting a challenge with the shared Wired Equivalent Privacy (WEP) key and requesting the device to decrypt it.

In step 4 (Association Request), after successful authentication (or in parallel with it), the UE 102 sends an association request frame to the AP 104, stating the UE's capabilities and desired parameters (e.g., supported data rates, encryption methods).

In step 5 (Association Response), the AP 104 replies with an association response frame, indicating whether the association is successful. If successful, then this frame includes the association identifier (AID) assigned to the UE 102 by the AP 104.

In step 6 (Four-Way Handshake (WPA/WPA2)), if using the WiFi Protected Access (WPA) or WPA2 protocol, then a four-way handshake occurs to establish encryption keys. The AP 104 and the UE 102 exchange messages to agree on encryption keys without disclosing them over the air.

In step 7 (Group Key Handshake (WPA/WPA2)), after the four-way handshake, a group key handshake occurs where the AP 104 periodically sends a new group key to all associated devices, including the UE 102, ensuring forward secrecy.

In step 8 (Connection Established), once the authentication, association, and key exchange processes are complete, the UE 102 is considered connected to the WiFi network and can transmit and receive data to and from the Internet (not shown in FIG. 1) via the AP 104.

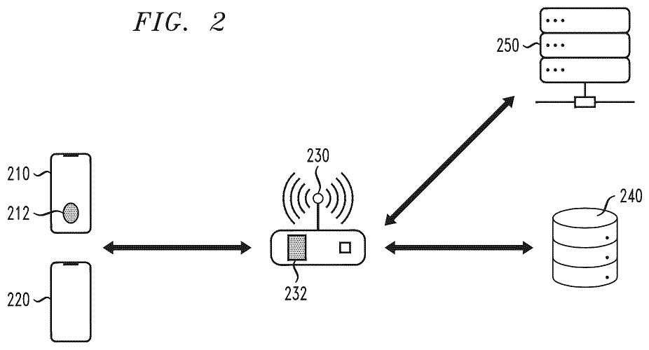

FIG. 2 is a simplified block diagram of a situation in which two different users attempt to use their UEs to access a company's ISP service via a WiFi network, where only one of the two users is a subscriber to the company's cellular service. In particular, the subscriber attempts to access the company's ISP service via WiFi AP 230 using the subscriber's UE 210, and the non-subscriber attempts to access that same ISP service via that same WiFi AP 230 using the non-subscriber's UE 220. The centralized MAC database 240 and the billing system 250 shown in FIG. 2 are part of the company's backend infrastructure. According to certain embodiments of the present disclosure, the subscriber's UE 210 and the WiFi AP 230 have respective (e.g., software) components 212 and 232 that (i) permit UE 210 to establish a WiFi connection to AP 230 to enable the UE 210 to access the Internet via the AP's WiFi network and (ii) effectively prevent the non-subscriber's UE 220 from doing likewise.

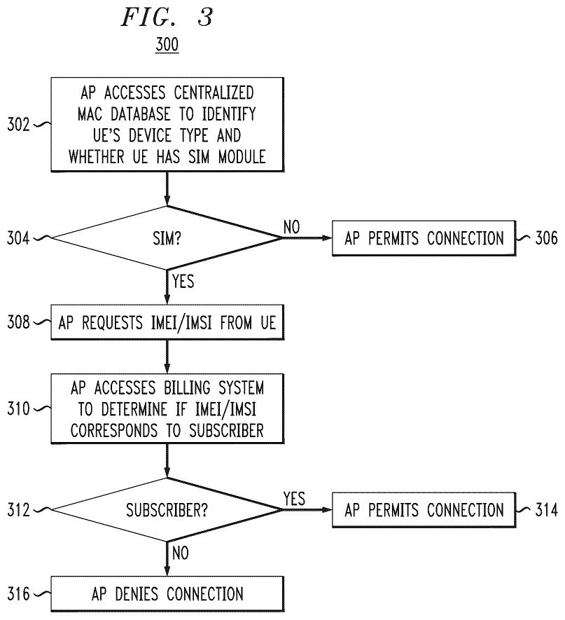

FIG. 3 is a flow diagram of the processing 300 performed by the AP's component 232 of FIG. 2 to determine whether or not to allow a UE to access the Internet via the AP's WiFi network. In step 302, using the MAC address received from the UE, the AP 230 accesses a static table in the centralized MAC database 240 of FIG. 2 to identify the device type of the UE and whether the UE has a physical or electronic Subscriber Identification Module (SIM) indicating that the UE has cellular communication capabilities. Different device types include (without limitation) phones, laptops, tablets, smart watches, set-up boxes, electric vehicles, smart TVs, IoT devices (such as Ring cameras, sound systems, thermostats, etc.). Some device types have SIM modules, while others do not.

If the AP 230 determines, in step 304, that the UE does not have a SIM module, then the UE does not have cellular communication capabilities, the AP 230 permits the UE to connect to the AP 230 in step 306, and the processing 300 of FIG. 3 ends. If, however, the AP 230 determines, in step 304, that the UE does have a SIM module, then the UE does have cellular communication capabilities, and, in step 308, depending on the implementation, the AP 230 requests either the International Mobile Equipment Identity (IMEI) number or the International Mobile Subscriber Identity (IMSI) number from the UE. As known in the art, an.

IMEI number identifies mobile device hardware, while an IMSI number identifies the mobile subscriber associated with a SIM module.

A 15-digit IMEI number consists of three parts:
Type Allocation Code (TAC): Identifies the manufacturer and model of the mobile device (8 digits).
Serial Number (SNR): Assigned by manufacturer to uniquely identify mobile devices having the same TAC number (6 digits).
Check Digit (CD): Used to verify IMEI's integrity and detect transmission errors (1 digit).

A 15-digit IMSI number consists of three parts:
Mobile Country Code (MCC): Identifies the country the subscriber is associated with (usually 2-3 digits).
Mobile Network Code (MNC): Identifies the specific mobile network operator (usually 1-3 digits).
Mobile Subscription Identification Number (MSIN): Uniquely identifies the subscriber within that network (usually 9-10 digits).

If the UE provides its IMEI/IMSI number in step 308, then, in step 310, the AP 230 accesses the company's billing system 250 of FIG. 2 to determine whether the IMEI/IMSI number corresponds to one of the company's cellular service subscribers.

If the AP 230 determines, in step 312, that the IMEI/IMSI number does correspond to one of the company's cellular subscribers, then, in step 314, the UE's request to connect to the AP's WiFi network is permitted; otherwise, in step 316, the request is denied.

Note that, if the UE has a SIM module, but is not associated with a company subscriber, then the UE might not be able to interpret the IMEI/IMSI request of step 308. In that case, the UE will not provide its IMEI/IMSI number to the AP 230 in step 308, steps 310-316 will not be performed, and the UE will not receive permission to connect to the AP's WiFi network.

In any case, by implementing the processing 300 of FIG. 3, AP 230 will allow the subscriber's UE 210 of FIG. 2 to access the Internet via the AP's WiFi network and deny similar access to the non-subscriber's UE 220, thereby restricting the company's ISP service to its cellular service subscribers.

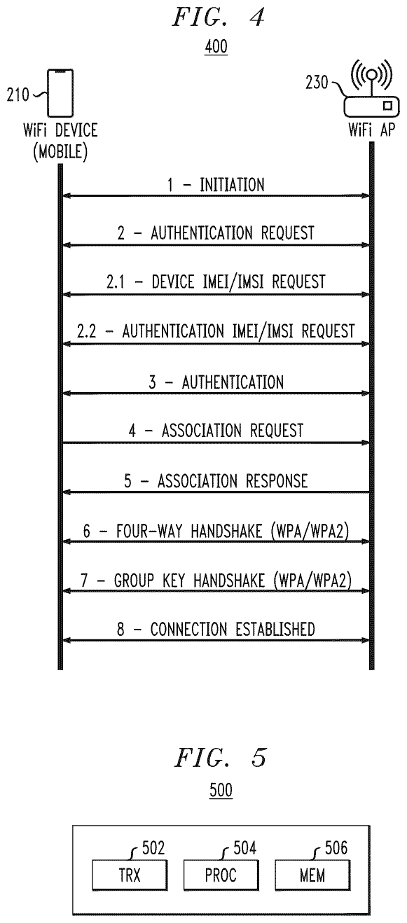

FIG. 4 is a message flow diagram representing a sequence 400 of messages transmitted between UE 210 and AP 230 of FIG. 2 to establish a wireless connection between UE 210 and AP 230 to enable the UE 210 to access the Internet via the AP's WiFi network according to an embodiment of the present disclosure. Steps 1-8 of FIG. 4 are identical to Step 1-8 of FIG. 1. Between steps 2 and 3 are the following new steps 2.1 and 2.2:

In step 2.1 (Device IMEI/IMSI Request), the AP 230 (i) determines that UE 210 has a SIM module based on the UE's MAC address (as in step 304 of FIG. 3) and (ii) requests the UE's IMEI/IMSI (as in step 308 of FIG. 3).

In step 2.2 (Authentication IMEI/IMSI Request), the AP 230 (i) validates the UE's IMEI/IMSI against the company's billing system 250 (as in steps 310 and 312 of FIG. 3) and (ii) allows the connection process to continue (as in step 314 of FIG. 3).

FIG. 5 is a simplified hardware block diagram of an example element 500 that can be used to implement any of the elements of FIG. 2. As shown in FIG. 5, the element 500 includes (i) communication hardware (e.g., wireless, wireline, and/or optical transceivers (TRX)) 502 that supports communications with other elements, (ii) one or more processors (e.g., CPU and/or GPU microprocessors) 504 that control the operations of the element 500 and/or process data within the element 500, and (iii) one or more memories (e.g., RAM, ROM) 506 that store code executed by the processors 504 and/or data generated and/or received by the element 500.

Although the processing of FIG. 3 always restricts Internet access to only the UEs associated with cellular service subscribers of the company, in some implementations, the processing 300 of FIG. 3 may be performed only some of the time and/or only in some locations, such that Internet access may be permitted to the UEs of users who are not cellular service subscribers of the company (aka external cellular subscribers) at other times and/or in other locations. Furthermore, in some implementations, Internet access may be permitted to the UEs of certain users who are not cellular service subscribers of the company based on the identity of the users, e.g., cellular service subscribers of another company that has a roaming agreement with the first company.

Although the disclosure has been described in the context of restricting access to the Internet via a WiFi network by denying non-subscriber UEs permission to connect to the WiFi network, in some embodiments, the UE may be permitted to connect to the WiFi network to perform other (e.g., local) network operations without providing the UE with access to the Internet.

Although the disclosure has been described in the context of UEs that can access the Internet via a WiFi network, those skilled in the art will understand that the disclosure can be implemented in the context of UEs that can access the Internet via other suitable non-cellular networks. In those implementations, the access point that performs the processing 300 of FIG. 3 will be an access point of those other suitable non-cellular networks.

In certain embodiments, the present disclosure is a method for selectively providing Internet access to user equipments (UEs) by a company that functions as both a cellular service provider and an Internet service provider. The method comprises receiving a request from a UE for Internet access via a non-cellular network; determining whether the UE is associated with a cellular service subscriber of the company; upon determining that the UE is associated with a cellular service subscriber of the company, permitting the Internet access by the UE via the non-cellular network; and upon determining that the UE (i) has cellular communication capabilities and (ii) is not associated with a cellular service subscriber of the company, denying the Internet access by the UE via the non-cellular network.

In at least some of the above embodiments, determining whether the UE is associated with a cellular service subscriber of the company comprises requesting an identification number from the UE; receiving the identification number from the UE; and using the identification number to determine whether the UE is associated with a cellular service subscriber of the company.

In at least some of the above embodiments, the UE's identification number is the UE's International Mobile Equipment Identity (IMEI) number.

In at least some of the above embodiments, the UE's identification number is the UE's International Mobile Subscriber Identity (IMSI) number.

In at least some of the above embodiments, the method further comprises, before requesting the identification number from the UE, (i) receiving the UE's medium access control (MAC) address from the UE and (ii) using the UE's MAC address to determine that the UE has an identification number.

In at least some of the above embodiments, the method further comprises, upon determining that the UE does not have cellular communication capabilities, permitting the Internet access by the UE via the non-cellular network.

In at least some of the above embodiments, the non-cellular network is a WiFi network.

In certain other embodiments, the present disclosure is a method for a UE receiving Internet service from a company that functions as both a cellular service provider and an Internet service provider, wherein the UE is associated with a subscriber of the company. The method comprises transmitting a request for Internet service via a non-cellular network; receiving a request for an identification number for UE; transmitting the identification number; and receiving permission to access the Internet via the non-cellular network.

In at least some of the above embodiments, the UE's identification number is the UE's IMEI number.

In at least some of the above embodiments, the UE's identification number is the UE's IMSI number.

In at least some of the above embodiments, the method further comprises, before receiving the request for the UE's identification number, transmitting the UE's MAC address.

In at least some of the above embodiments, the non-cellular network is a WiFi network.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for selectively providing Internet access to user equipments (UEs) by a company that functions as both a cellular service provider and an Internet service provider, the method comprising:
receiving a request from a UE for Internet access via a non-cellular network;
determining whether the UE is associated with a cellular service subscriber of the company;
upon determining that the UE is associated with a cellular service subscriber of the company, permitting the Internet access by the UE via the non-cellular network; and
upon determining that the UE (i) has cellular communication capabilities and (ii) is not associated with a cellular service subscriber of the company, denying the Internet access by the UE via the non-cellular network.

2. The method of claim 1, wherein determining whether the UE is associated with a cellular service subscriber of the company comprises:
requesting an identification number from the UE;
receiving the identification number from the UE; and
using the identification number to determine whether the UE is associated with a cellular service subscriber of the company.

3. The method of claim 2, wherein the UE's identification number is the UE's International Mobile Equipment Identity (IMEI) number.

4. The method of claim 2, wherein the UE's identification number is the UE's International Mobile Subscriber Identity (IMSI) number.

5. The method of claim 2, further comprising, before requesting the identification number from the UE:
receiving the UE's medium access control (MAC) address from the UE; and
using the UE's MAC address to determine that the UE has an identification number.

6. The method of claim 1, further comprising, upon determining that the UE does not have cellular communication capabilities, permitting the Internet access by the UE via the non-cellular network.

7. The method of claim 1, wherein the non-cellular network is a WiFi network.

8. Backend infrastructure of a company that functions as both a cellular service provider and an Internet service provider, the backend infrastructure comprising:
a memory; and
at least one processor, coupled to the memory and operative to:
receive a request from a UE for Internet access via a non-cellular network;
determine whether the UE is associated with a cellular service subscriber of the company;
upon determining that the UE is associated with a cellular service subscriber of the company, permit the Internet access by the UE via the non-cellular network; and
upon determining that the UE (i) has cellular communication capabilities and (ii) is not associated with a cellular service subscriber of the company, deny the Internet access by the UE via the non-cellular network.

9. The backend infrastructure of claim 8, wherein, in determining whether the UE is associated with a cellular service subscriber of the company, the backend infrastructure is adapted to:
request an identification number from the UE;
receive the identification number from the UE; and
use the identification number to determine whether the UE is associated with a cellular service subscriber of the company.

10. The backend infrastructure of claim 9, wherein the UE's identification number is the UE's IMEI number.

11. The backend infrastructure of claim 9, wherein the UE's identification number is the UE's IMSI number.

12. The backend infrastructure of claim 9, wherein, before requesting the identification number from the UE, the backend infrastructure is adapted to:
receive the UE's medium access control (MAC) address from the UE; and
use the UE's MAC address to determine that the UE has an identification number.

13. The backend infrastructure of claim 8, wherein, upon determining that the UE does not have cellular communication capabilities, the backend infrastructure is adapted to permit the Internet access by the UE via the non-cellular network.

14. The backend infrastructure of claim 8, wherein the non-cellular network is a WiFi network.

15. A method for a UE receiving Internet service from a company that functions as both a cellular service provider and an Internet service provider, wherein the UE is associated with a subscriber of the company, the method comprising:
transmitting a request for Internet service via a non-cellular network;
receiving a request for an identification number for UE;
transmitting the identification number; and
receiving permission to access the Internet via the non-cellular network.

16. The method of claim 15, wherein the UE's identification number is the UE's IMEI number.

17. The method of claim 15, wherein the UE's identification number is the UE's IMSI number.

18. The method of claim 15, further comprising, before receiving the request for the UE's identification number, transmitting the UE's MAC address.

19. The method of claim 15, wherein the non-cellular network is a WiFi network.

20. A UE comprising:
a memory; and
at least one processor, coupled to the memory and operative to:
transmit a request for Internet service via a non-cellular network;
receive a request for an identification number for UE;
transmit the identification number; and
receive permission to access the Internet via the non-cellular network.

21. The UE of claim 20, wherein the UE's identification number is the UE's IMEI number.

22. The UE of claim 20, wherein the UE's identification number is the UE's IMSI number.

23. The UE of claim 20, wherein, before receiving the request for the UE's identification number, the UE is adapted to transmit the UE's MAC address.

24. The UE of claim 20, wherein the non-cellular network is a WiFi network.
